(19) United States
(12) Patent Application Publication
(10) Pub. No.: US 2004/0166282 A1
(43) Pub. Date: Aug. 26, 2004

(54) Woven fastener products

(76) Inventors: Howard A. Kingsford, Amherst, NH (US); Der-Shi Wang, Bedford, NH (US)

Correspondence Address: FISH & RICHARDSON PC, 225 FRANKLIN ST, BOSTON, MA, 02110, US

(21) Appl. No.: 10/371,844

(22) Filed: Feb. 20, 2003

(51) Int. Cl. B32B 33/00; B32B 3/06

(52) U.S. Cl. 428/95; 428/97; 428/99; 428/100

(57) ABSTRACT

Woven fastener products are provided for hook and loop fastening, that include flame resistant materials such as glass fibers, sodium silicate and thermosetting adhesive binders. The products are useful for securing articles in fire-sensitive environments, such as on board aircraft.

### TECHNICAL FIELD

This invention relates to woven fastener products, and more particularly to woven fastener products for use in hook and loop fasteners.

### BACKGROUND

Woven fastener products include a fabric base from which tiny fastener elements extend. The fastener elements are manufactured by projecting loops of yarns from the fabric base during the weaving process. Loops of multifilament yarns can function as female fastening elements. In other cases, loops of monofilament fibers can be cut and/or heated, after weaving, to produce male fastener elements having, for example, hook or mushroom shapes. Generally, the monofilament fibers from which the male fastener elements are formed are woven into the fabric base, while the multifilament yarns that form the loops are woven or knitted into the base.

Generally, the material of the fibers forming the fastener elements is selected for tenacity and flexibility, and other properties useful for functioning as a fastener element, and for weavability or ease of knitting. Similarly, the material of the fibers forming the fabric base are selected for weavability.

In order to secure the hook or loop elements to the fabric base, and to bond the fibers of the base to each other, the fabric base is impregnated with a binder. Generally, the binder is a polymeric material. The binder adds strength and durability to the fastener product, and allows it to withstand a number of cycles of closing and opening the fastener without detachment of the fastener elements from the base or fraying of the base.

To form a closure, male fastener elements engage overlying female fastener elements. Certain fastener products, sometimes referred to as “hermaphroditic” fasteners, have arrays that include both male and female fastener elements and thus can self-engage.

### SUMMARY

The invention features a fastener product with enhanced flame resistant properties. Woven fastener products are provided that can have good flame resistance as defined in ASTM D 4391. Some preferred fastener products can be used in applications that have stringent safety specifications, such as in commercial aircraft. The fastener products also can provide good strength and durability.

In one aspect, the invention features a fastener component including: (a) a woven fabric base including flame resistant fibers; and (b) woven into the fabric base, a plurality of fibers of a polymer that will melt or disintegrate when exposed to flame, the fibers forming fastener elements extending from a broad side of the base for releasable engagement with an associated fastener component.

Some implementations include one or more of the following features. The fastener component further includes a binder including a flame resistant material. Preferably, the binder consists essentially of a flame resistant material. The woven fabric base includes glass fibers. The polymer includes polyetheretherketone. The flame resistant material includes sodium silicate. The fastener elements include loops. The fastener elements include male fastener elements, e.g., hooks.

In another aspect, the invention features a fastener including: (a) a woven fabric base formed of glass fibers; (b) woven into the fabric base, a plurality of fastener elements formed of polyetheretherketone resin; and (c) a binder consisting essentially of sodium silicate.

Another aspect of the invention features a hook and loop fastener including a hook component and a loop component configured for engagement with the hook component, the hook and loop components both having sufficient flame resistance to meet the requirements of DOT/FAA/AR-99/44.

We have found that fastener products can effectively be woven from the materials described herein, to produce a fastener having flammability, smoke release and heat release properties sufficient to meet requirements for use in commercial aircraft, e.g., within the passenger compartments of such aircraft, while still providing effective fastening properties. Some of the fastener products can meet the standards of NFPA 701, FAR 25.853 (requirements for compartment interiors), and/or the United States Federal Aviation Administration (FAA)'s new flame resistance criteria under development (DOT/FAA/AR-99/44).

Another aspect of the invention features securing an article in place on board an aircraft with the fastener components described herein.

The details of one or more embodiments of the invention are set forth in the accompanying drawings and the description below. Other features and advantages of the invention will be apparent from the description and drawings, and from the claims.

### DESCRIPTION OF DRAWINGS

FIG. 1 is a diagrammatic perspective view of a woven fastener product.

FIG. 2 is a highly enlarged perspective view of the hook component of the fastener product of FIG. 1.

FIG. 3 is a highly enlarged cross-sectional view of the loop component of the fastener element of FIG. 1.

### DETAILED DESCRIPTION

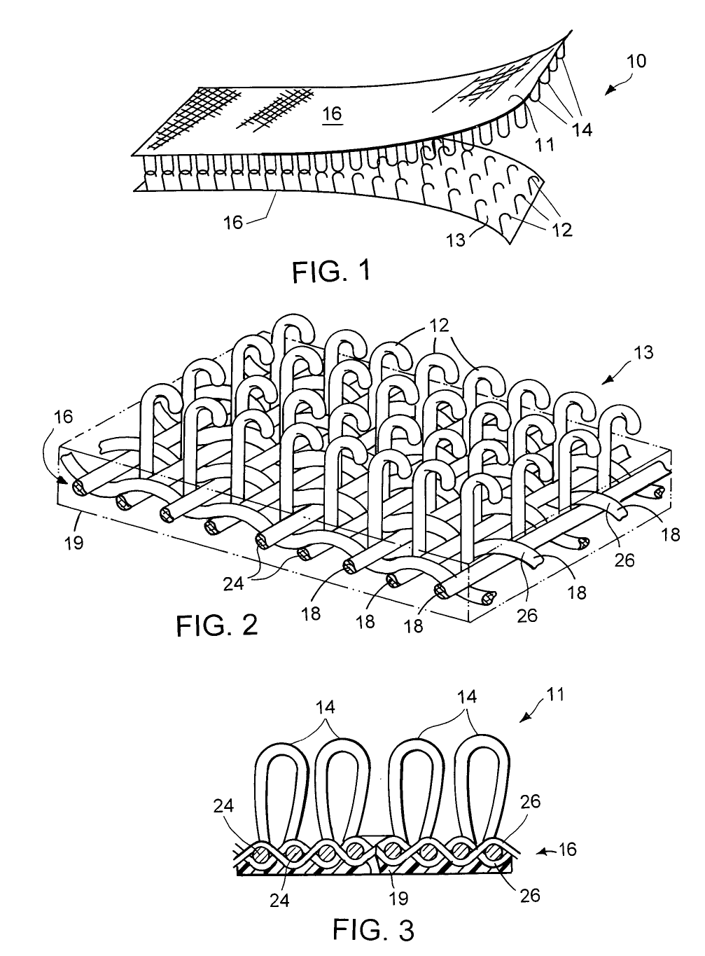

An example of a woven fastener product 10 is shown in FIG. 1. Woven fastener product 10 includes a loop component 11 and a hook component 13 constructed for engagement with loop component 11. Loop component 11 includes a plurality of loops 14 that are woven or knitted into a fabric base, or “ground” 16. Hook component 13 includes hooks 12 that are woven into a similar ground 16. In order to secure the hooks and loops, referred to herein as fastener elements, to the ground 16, the ground is impregnated with a binder 19 (see FIG. 2, in which binder 19 is indicated by phantom lines). In addition to securing the fastener elements, the binder also bonds the fibers 18 composing the ground to each other, enhancing the structural integrity of the fastener product.

Referring to FIGS. 2 and 3, the fabric base 16 is made of an interlacing pattern of fibers including warp yarns 26 that extend in the warp direction and weft yarns 24 that extend in the weft direction. Some of the warp yarns are used to form the hooks 12 or loops 14. These warp yarns should be of a material that is suitable for use as a fastener element, and thus these fibers will generally have a greater requirement for tenacity and flexibility than yarns that form only the ground. The yarns that form only the ground (in most cases, all of the weft yarns and some of the warp yarns) are formed of flame resistant fibers.

Suitable flame resistant fibers include glass fibers. Suitable glass fibers include multifilament yarns having a denier of from about 200 to 800. Such yarns are commonly available commercially, for example from Owens Corning. Other suitable fibers may include fibers formed from polyetheretherketone (PEEK), polyphenylene sulfide (PPS), carbon, ceramic, polyamide-imide (PAI), polyarylene sulfide (PAS), novoloids, basalt and stainless steel.

Suitable binder materials provide the fastener product with the flame resistance properties that are required for a particular application. A binder that provides excellent flame resistance is a silicate solution coating, also known as a waterglass solution. Such solutions are widely used as fire retardants in textiles, and are readily available commercially. A suitable binder, for example, is LADH7413, a one part thermosetting, solvent based adhesive available from Bostik Findley in Middleton, Mass.

The yarns that form hook elements 12 and loop elements 14 are formed of a polymeric material that will disintegrate or melt when exposed to flame or very high temperatures such as would be encountered in a fire. We have found that the melting or disintegration of these yarns prevents the yarns from propagating fire over the length and width of the fastener product.

Preferred polymers are self-extinguishing, and exhibit low flammability (UL94), ignitability (Limiting Oxygen Index, ASTM D2863-95), and smoke and toxic gas emission (Specific Optical Density, ASTM E662-95). Generally, preferred polymers have a UL94 flammability rating of V-0 at 1.45 mm thickness, a Limiting Oxygen Index of about 30-45%, and a Specific Optical Density of 50 or less. One suitable polymer is polyetheretherketone (PEEK).

Preferably, the yarns used to form the hook elements are monofilament yarns having a denier of about 200 to 600, and the yarns used to form the loop elements are multifilament yarns having a denier of from about 100 to 600 and a filament count of about 5 to 30. Preferably both yarns have a tenacity of at least 4 grams/denier. Suitable PEEK yarns are available, for example, from ZYEX Ltd., Stonedale Road, Stonehouse, United Kingdom GL10 3RQ.

Preferably, the fastener product is substantially free of components that would deleteriously affect the flame resistance of the product and/or produce unacceptable levels of smoke and/or gas emissions when the product is exposed to flame.

Typically, but not exclusively, hook elements 12 have heights in the range of 0.050 inch to 0.10 inch and the hook element array includes greater than 100 hook elements per square inch and, in some cases, greater than 500 hook elements per square inch. Generally, loop elements 16 have heights on the order of 0.050 inch to 0.150 inch. The density of the loop array can be up to five to twenty times greater than that of the hook array because, as described further below, loop elements are generally made from multifilament yarns with each filament capable of forming a loop element, while hook elements are generally made from monofilament fibers.

The thickness of the fabric base 16 is primarily determined by the load that the product must withstand in use. Typically, the fabric base 16 of the fastener product has a thickness between 0.012 inch and 0.10 inch, but in some cases, can have a thickness of up to 0.50 inch or even greater. For the purpose of this application, fastener products having a base thickness greater than 0.030 inch and a tensile strength in the warp direction of at least 300 pounds per lineal inch of width are defined as fastener webbings. Fastener webbings are suitable for use in load-bearing applications and also can be used to enhance appearance and for handling purposes. Fastener products having bases thinner than 0.030 inch are defined as fastener tapes which are used in applications involving relatively light loading.

Weaving techniques for anchoring fastener elements to the fabric base 16 may be used in combination with the binder material to reinforce the anchoring.

Other embodiments are within the scope of the following claims.

For example, while the fastener product described above includes a combination of a flame resistant ground, a flame resistant binder, and fastener elements of a polymer that will melt or disintegrate when exposed to flame, in applications having less stringent flame resistance requirements one or more of these features may be used alone.

Also, while fastener products having a hook component and a separate loop component have been shown and described above, the components described herein may be used in any desired type of fastener product. For example, the product may be woven to have both male and female fastener elements extending from a common surface, such that the single fastener component can releasably engage itself, as known in the art.

What is claimed is:

1. A fastener component comprising:
a woven fabric base including flame resistant fibers; and
woven into the fabric base, a plurality of fibers of a polymer that will melt or disintegrate when exposed to flame, the fibers forming fastener elements extending from a broad side of the base for releasable engagement with an associated fastener component.

2. The fastener component of claim 1, further comprising a binder including a flame resistant material.

3. The fastener component of claim 1 wherein the binder consists essentially of the flame resistant material.

4. The fastener component of claim 2 wherein the flame resistant material comprises sodium silicate.

5. The fastener component of claim 2 wherein the binder comprises a thermosetting polymer adhesive.

6. The fastener component of claim 1 wherein the woven fabric base comprises glass fibers.

7. The fastener component of claim 1 wherein the polymer comprises polyetheretherketone.

8. The fastener component of claim 1 wherein the fabric base comprises an interlacing pattern of fibers including warp yarns and weft yarns, some of either the warp or weft yarns comprising the flame resistant fibers, and others of either the warp or weft yarns comprising the fibers forming fastener elements.

9. The fastener component of claim 8 wherein the flame resistant fibers comprise essentially all of either the warp or weft yarns.

10. The fastener component of claim 1 wherein the fibers forming the fastener elements have a tenacity of at least 4 grams/denier.

11. The fastener component of claim 1 wherein the fastener elements comprise loops.

12. The fastener component of claim 11 wherein the fibers forming the loops comprise multifilament yarns having a denier of between about 100 and 600 and a filament count of between about 5 and 30 filaments per yarn.

13. The fastener component of claim 1 wherein the fastener elements comprise male fastener elements.

14. The fastener component of claim 13 wherein the fibers forming the male fastener elements comprise monofilament yarns having a denier of between about 200 and 600.

15. The fastener component of claim 13 wherein the male fastener elements comprise loop-engageable elements.

16. The fastener component of claim 13 wherein the male fastener elements comprise hooks.

17. The fastener component of claim 1 wherein the polymer has a UL94 flammability rating of V-0 at 1.45 millimeters of thickness.

18. The fastener component of claim 1 wherein the polymer has a Limiting Oxygen Index of about 30 percent to about 45 percent.

19. The fastener component of claim 1 wherein the polymer has a Specific Optical Density of less than about 50.

20. The fastener component of claim 1 wherein the fibers are of a material selected from the group consisting of glass, polyetheretherketone, polyphenylene sulfide, carbon, ceramic, polyamide-imide, polyarylene sulfide, novoloids, basalt and stainless steel.

21. A fastener comprising:
a woven fabric base formed of glass fibers;
woven into the fabric base, a plurality of fastener elements formed of polyetheretherketone resin; and
a binder consisting essentially of sodium silicate.

22. A hook and loop fastener comprising
a hook component; and
a loop component configured for engagement with the hook component;
the hook and loop components both having sufficient flame resistance to meet the requirements of DOT/FAA/AR-99/44.

23. A method of securing an article on board an aircraft, the method comprising
securing one fastener component to the article, and a mating fastener component to the aircraft, at least one of the fastener components comprising a woven fabric base including flame resistant fibers, and woven into the fabric base, a plurality of fibers of a polymer that will melt or disintegrate when exposed to flame, the fibers forming fastener elements extending from a broad side of the base for releasable engagement with the other fastener component; and
engaging the fastener components together to releasably secure the article in a desired location on board the aircraft.
